(19) United States
(12) Patent Application Publication
(10) Pub. No.: US 2015/0347579 A1
(43) Pub. Date: Dec. 3, 2015

(54) MEDIA FILE MARKING METHOD AND APPARATUS

(71) Applicants: Simon EKSTRAND, Eslov (SE); HUAWEI TECHNOLOGIES CO., LTD., Shenzhen (CN)

(72) Inventors: Li HUA, Shenzhen (CN); Shaoting FAN, Shenzhen (CN); Simon EKSTRAND, Eslov (SE)

(21) Appl. No.: 14/725,034

(22) Filed: May 29, 2015

(30) Foreign Application Priority Data
May 30, 2014 (CN) 201410239133.4

(51) Int. Cl. G06F 17/30

(52) U.S. Cl. CPC G06F 17/30817; G06F 17/30705

(57) ABSTRACT

Embodiments of the present invention provide a media file marking method and apparatus. The media file marking method includes: receiving reaction information that is generated when a user watches a media file and is sent by at least one first terminal device, where the reaction information is collected by the first terminal device when the user watches the media file; generating marking information of the media file according to the reaction information sent by the at least one first terminal device; and sending the marking information of the media file to a second terminal device that plays the media file, so that the second terminal device displays the marking information of the media file. The media file marking method and apparatus provided in the embodiments of the present invention are used to improve accuracy of choosing a media file by a user.

### CROSS-REFERENCE TO RELATED APPLICATIONS

This application claims priority to Chinese Patent Application No. 201410239133.4, filed on May 30, 2014, which is incorporated herein by reference in its entirety.

### TECHNICAL FIELD

Embodiments of the present invention relate to network technologies, and in particular, to a media file marking method and apparatus.

### BACKGROUND

With the development of network technologies, bandwidth of a network accessed by a home user can already meet a requirement of video on demand. Therefore, video on demand services already become major means of leisure and entertainment for an increasing number of people.

Because of abundant video files such as various movies, television series, micro movies, news programs, and variety shows on networks, to help a user select an appropriate video file for watching, a video file provider (for example, a website or a video uploader) generally categorizes the video files and adds a brief text introduction. The user selects an interesting video file in a corresponding category for watching according to a requirement and by referring to content of the text introduction.

However, a category of and a text introduction to a video file are edited only by a video provider, and can merely reflect basic information about the video file and an introduction to the video file made by the provider according to a subjective judgment of the provider. The category and the text introduction may even be false content provided by the video file provider to attract more users to watch the video file. In addition, each person may have a different feeling for a same video file. Therefore, when the user selects a video file only according to a category and a text introduction, made by a video file provider, of the video file, a video file that the user wants to watch cannot be picked out in most cases.

### SUMMARY

Embodiments of the present invention provide a media file marking method and apparatus, used to improve accuracy for choosing a media file by a user.

According to a first aspect, a media file marking method is provided, including:

receiving reaction information that is generated when a user watches a media file and is sent by at least one first terminal device, where the reaction information is collected by the first terminal device when the user watches the media file;

generating marking information of the media file according to the reaction information sent by the at least one first terminal device; and

sending the marking information of the media file to a second terminal device that plays the media file, so that the second terminal device displays the marking information of the media file.

With reference to the first aspect, in a first possible implementation manner of the first aspect, the marking information of the media file includes a category identifier of the media file;

the generating marking information of the media file according to the reaction information sent by the at least one first terminal device includes:

generating the category identifier of the media file according to the reaction information sent by the at least one first terminal device; and

the sending the marking information of the media file to a second terminal device that plays the media file, so that the second terminal device displays the marking information of the media file includes:

sending the category identifier of the media file to the second terminal device that plays the media file, so that the second terminal device displays the category identifier of the media file on a display page or in the user interface of the media file.

With reference to the first aspect, in a second possible implementation manner of the first aspect, the marking information of the media file includes a reaction line graph of the media file;

before the generating marking information of the media file according to the reaction information sent by the at least one first terminal device, the method further includes:

receiving time information corresponding to the reaction information sent by the at least one first terminal device;

the generating marking information of the media file according to the reaction information sent by the at least one first terminal device includes:

generating the reaction line graph according to the reaction information sent by the at least one first terminal device, and the time information corresponding to the reaction information, where the reaction line graph includes a correspondence between reaction information of which a proportion is highest in one time unit when the media file is played, and the one time unit; and

the sending the marking information of the media file to a second terminal device that plays the media file, so that the second terminal device displays the marking information of the media file includes:

sending the reaction line graph of the media file to the second terminal device that plays the media file, so that the second terminal device displays the correspondence between reaction information of which a proportion is highest in one time unit of the media file and the one time unit on a playback page of the media file.

With reference to the second possible implementation manner of the first aspect, in a third possible implementation manner of the first aspect, before the sending the marking information of the media file to a second terminal device that plays the media file, the method further includes:

using a category identifier corresponding to the reaction information of which the proportion is highest in the one time unit and the proportion is higher than a preset threshold as the category identifier of the media file; and

the sending the marking information of the media file to a second terminal device that plays the media file, so that the second terminal device displays the marking information of the media file includes:

sending the category identifier of the media file to the second terminal device that plays the media file, so that the second terminal device displays the category identifier of the media file.

With reference to any possible implementation manner from the first aspect to the third possible implementation manner of the first aspect, in a fourth possible implementation manner of the first aspect, the reaction information includes at least one of the following: sound information, expression information, action information, and physiological information.

According to a second aspect, a media file marking method is provided, including:

collecting reaction information generated when a user watches a media file; and

sending the reaction information to a media file server, so that after receiving the reaction information sent by at least one terminal device, the media file server generates marking information of the media file and sends the marking information of the media file to a terminal device that plays the media file.

With reference to the second aspect, in a first possible implementation manner of the second aspect, the marking information of the media file includes a category identifier of the media file;

the sending the reaction information to a media file server, so that after receiving the reaction information sent by at least one terminal device, the media file server generates marking information of the media file and sends the marking information of the media file to a terminal device that plays the media file includes:

sending the reaction information to the media file server, so that after receiving the reaction information sent by the at least one terminal device, the media file server generates the category identifier of the media file and sends the category identifier of the media file to the terminal device that plays the media file.

With reference to the second aspect, in a second possible implementation manner of the second aspect, the marking information of the media file includes a reaction line graph of the media file;

the collecting reaction information generated when a user watches a media file includes:

collecting the reaction information generated when the user watches the media file, and time information corresponding to the reaction information generated when the user watches the media file; and

the sending the reaction information to a media file server, so that after receiving the reaction information sent by at least one terminal device, the media file server generates marking information of the media file and sends the marking information of the media file to a terminal device that plays the media file includes:

sending, to the media file server, the reaction information and the time information that corresponds to the reaction information generated when the user watches the media file, so that after receiving the reaction information sent by the at least one terminal device, and the time information corresponding to the reaction information generated when the user watches the media file, the media file server generates the reaction line graph and sends the reaction line graph to the terminal device that plays the media file, where the reaction line graph includes a correspondence between reaction information of which a proportion is highest in one time unit when the media file is played, and the one time unit.

With reference to any possible implementation manner from the second aspect to the second possible implementation manner of the second aspect, in a third possible implementation manner of the second aspect, the collecting reaction information generated when a user watches a media file includes:

collecting, by using a peripheral device, the reaction information generated when the user watches the media file, where the peripheral device includes at least one of the following: a voice collecting device, a video collecting device, and a physiology collecting device; and

the reaction information includes at least one of the following: sound information, expression information, action information, and physiological information.

According to a third aspect, a media file marking method is provided, including:

receiving marking information, sent by a media file server, of a media file, where the marking information of the media file is generated after the media file server receives reaction information collected by at least one first terminal device when a user watches the media file; and

displaying the marking information of the media file.

With reference to the third aspect, in a first possible implementation manner of the third aspect, the marking information of the media file includes a category identifier of the media file;

the receiving marking information, sent by a media file server, of a media file, where the marking information of the media file is generated after the media file server receives reaction information collected by at least one first terminal device when a user watches the media file includes:

receiving the category identifier, sent by the media file server, of the media file, where the category identifier of the media file is generated after the media file server receives the reaction information collected by the at least one first terminal device when the user watches the media file; and

the displaying the marking information of the media file includes:

displaying the category identifier of the media file on a display page or in the user interface of the media file.

With reference to the third aspect, in a second possible implementation manner of the third aspect, the marking information of the media file includes a reaction line graph of the media file;

the receiving marking information, sent by a media file server, of a media file, where the marking information of the media file is generated after the media file server receives reaction information collected by at least one first terminal device when a user watches the media file includes:

receiving the reaction line graph, sent by the media file server, of the media file, where the reaction line graph of the media file is generated after the media file server receives the reaction information collected by the at least one first terminal device when the user watches the media file, and time information corresponding to the reaction information generated when the user watches the media file, where the reaction line graph includes a correspondence between reaction information of which a proportion is highest in one time unit when the media file is played, and the one time unit; and

the displaying the marking information of the media file includes:

displaying the correspondence between reaction information of which a proportion is highest in one time unit of the media file and the time unit on a playback page of the media file.

With reference to the second possible implementation manner of the third aspect, in a third possible implementation manner of the third aspect, the displaying the marking information of the media file further includes:

displaying a category identifier of the media file on a display page or in the user interface of the media file, where the category identifier of the media file is a category identifier corresponding to the reaction information of which the proportion is highest in the one time unit and the proportion is higher than a preset threshold.

With reference to any possible implementation manner from the third aspect to the third possible implementation manner of the third aspect, in a fourth possible implementation manner of the third aspect, the reaction information includes at least one of the following: sound information, expression information, action information, and physiological information.

According to a fourth aspect, a media file server is provided, including:

a receiving module, configured to receive reaction information that is generated when a user watches a media file and is sent by at least one first terminal device, where the reaction information is collected by the first terminal device when the user watches the media file;

a processing module, configured to generate marking information of the media file according to the reaction information sent by the at least one first terminal device; and

a sending module, configured to send the marking information of the media file to a second terminal device that plays the media file, so that the second terminal device displays the marking information of the media file.

With reference to the fourth aspect, in a first possible implementation manner of the fourth aspect, the marking information of the media file includes a category identifier of the media file;

the processing module is specifically configured to generate the category identifier of the media file according to the reaction information sent by the at least one first terminal device; and

the sending module is specifically configured to send the category identifier of the media file to the second terminal device that plays the media file, so that the second terminal device displays the category identifier of the media file on a display page or in the user interface of the media file.

With reference to the fourth aspect, in a second possible implementation manner of the fourth aspect, the marking information of the media file includes a reaction line graph of the media file;

the receiving module is further configured to receive time information corresponding to the reaction information sent by the at least one first terminal device;

the processing module is specifically configured to generate the reaction line graph according to the reaction information sent by the at least one first terminal device, and the time information corresponding to the reaction information, where the reaction line graph includes a correspondence between reaction information of which a proportion is highest in one time unit when the media file is played, and the one time unit; and

the sending module is specifically configured to send the reaction line graph of the media file to the second terminal device that plays the media file, so that the second terminal device displays the correspondence between reaction information of which a proportion is highest in one time unit of the media file and the one time unit on a playback page of the media file.

With reference to the second possible implementation manner of the fourth aspect, in a third possible implementation manner of the fourth aspect, the processing module is further configured to use a category identifier corresponding to the reaction information of which the proportion is highest in the one time unit and the proportion is higher than a preset threshold as a category identifier of the media file; and

the sending module is specifically configured to send the category identifier of the media file to the second terminal device that plays the media file, so that the second terminal device displays the category identifier of the media file.

With reference to any possible implementation manner from the fourth aspect to the third possible implementation manner of the fourth aspect, in a fourth possible implementation manner of the fourth aspect, the reaction information includes at least one of the following: sound information, expression information, action information, and physiological information.

According to a fifth aspect, a terminal device is provided, including:

a collecting module, configured to collect reaction information generated when a user watches a media file; and

a sending module, configured to send the reaction information to a media file server, so that after receiving the reaction information sent by at least one terminal device, the media file server generates marking information of the media file and sends the marking information of the media file to a terminal device that plays the media file.

With reference to the fifth aspect, in a first possible implementation manner of the fifth aspect, the marking information of the media file includes a category identifier of the media file; and

the sending module is specifically configured to send the reaction information to the media file server, so that after receiving the reaction information sent by the at least one terminal device, the media file server generates the category identifier of the media file and sends the category identifier of the media file to the terminal device that plays the media file.

With reference to the fifth aspect, in a second possible implementation manner of the fifth aspect, the marking information of the media file includes a reaction line graph of the media file;

the collecting module is specifically configured to collect the reaction information generated when the user watches the media file, and time information corresponding to the reaction information generated when the user watches the media file; and

the sending module is specifically configured to send, to the media file server, the reaction information and the time information that corresponds to the reaction information generated when the user watches the media file, so that after receiving the reaction information sent by the at least one terminal device, and the time information corresponding to the reaction information generated when the user watches the media file, the media file server generates the reaction line graph and sends the reaction line graph to the terminal device that plays the media file, where the reaction line graph includes a correspondence between reaction information of which a proportion is highest in one time unit when the media file is played, and the one time unit.

With reference to any possible implementation manner from the fifth aspect to the second possible implementation manner of the fifth aspect, in a third possible implementation manner of the fifth aspect, the collecting module is specifically configured to collect, by using a peripheral device, the reaction information generated when the user watches the media file, where the peripheral device includes at least one of the following: a voice collecting device, a video collecting device, and a physiology collecting device; and

the reaction information includes at least one of the following: sound information, expression information, action information, and physiological information.

According to a sixth aspect, a terminal device is provided, including:

a receiving module, configured to receive marking information, sent by a media file server, of a media file, where the marking information of the media file is generated after the media file server receives reaction information collected by at least one first terminal device when a user watches the media file; and

a displaying module, configured to display the marking information of the media file.

With reference to the sixth aspect, in a first possible implementation manner of the sixth aspect, the marking information of the media file includes a category identifier of the media file;

the receiving module is specifically configured to receive the category identifier, sent by the media file server, of the media file, where the category identifier of the media file is generated after the media file server receives the reaction information collected by the at least one first terminal device when the user watches the media file; and

the displaying module is specifically configured to display the category identifier of the media file on a display page or in the user interface of the media file.

With reference to the sixth aspect, in a second possible implementation manner of the sixth aspect, the marking information of the media file includes a reaction line graph of the media file;

the receiving module is specifically configured to receive the reaction line graph, sent by the media file server, of the media file, where the reaction line graph of the media file is generated after the media file server receives the reaction information collected by the at least one first terminal device when the user watches the media file, and time information corresponding to the reaction information generated when the user watches the media file, where the reaction line graph includes a correspondence between reaction information of which a proportion is highest in one time unit when the media file is played, and the one time unit; and

the displaying module is specifically configured to display the correspondence between reaction information of which a proportion is highest in one time unit of the media file and the one time unit on a playback page of the media file.

With reference to the second possible implementation manner of the sixth aspect, in a third possible implementation manner of the sixth aspect, the displaying module is further configured to display a category identifier of the media file on a display page or in the user interface of the media file, where the category identifier of the media file is a category identifier corresponding to the reaction information of which the proportion is highest in the one time unit and the proportion is higher than a preset threshold.

With reference to any possible implementation manner from the sixth aspect to the third possible implementation manner of the sixth aspect, in a fourth possible implementation manner of the sixth aspect, the reaction information includes at least one of the following: sound information, expression information, action information, and physiological information.

According to the media file marking method and apparatus provided in the embodiments of the present invention, reaction information of a user generated when the user watches a media file, and the media file is marked and categorized according to reaction information of all users who watch the media file on the network, so that the user can quickly pick out a desired media file for watching.

### BRIEF DESCRIPTION OF DRAWINGS

To describe the technical solutions in the embodiments of the present invention or in the prior art more clearly, the following briefly introduces the accompanying drawings required for describing the embodiments or the prior art. Apparently, the accompanying drawings in the following description show some embodiments of the present invention, and a person of ordinary skill in the art may still derive other drawings from these accompanying drawings without creative efforts.

FIG. 1 is a schematic diagram of an existing video on demand page;

FIG. 2 is a flowchart of Embodiment 1 of a media file marking method according to the present invention;

FIG. 3 is a flowchart of Embodiment 2 of a media file marking method according to the present invention;

FIG. 4 is a schematic diagram of a reaction line graph of a media file;

FIG. 5 is a flowchart of Embodiment 3 of a media file marking method according to the present invention;

FIG. 6 is a flowchart of Embodiment 4 of a media file marking method according to the present invention;

FIG. 7 is a flowchart of Embodiment 5 of a media file marking method according to an embodiment of the present invention;

FIG. 8 is a schematic diagram of a display page of a media file according to the present invention;

FIG. 9 is a schematic structural diagram of Embodiment 1 of a media file server according to an embodiment of the present invention;

FIG. 10 is a schematic structural diagram of Embodiment 1 of a terminal device according to an embodiment of the present invention;

FIG. 11 is a schematic structural diagram of Embodiment 2 of a terminal device according to an embodiment of the present invention;

FIG. 12 is a schematic structural diagram of Embodiment 2 of a media file server according to an embodiment of the present invention;

FIG. 13 is a schematic structural diagram of Embodiment 3 of a terminal device according to an embodiment of the present invention; and

FIG. 14 is a schematic structural diagram of Embodiment 4 of a terminal device according to an embodiment of the present invention.

### DESCRIPTION OF EMBODIMENTS

To make the objectives, technical solutions, and advantages of the embodiments of the present invention clearer, the following clearly describes the technical solutions in the embodiments of the present invention with reference to the accompanying drawings in the embodiments of the present invention. Apparently, the described embodiments are some but not all of the embodiments of the present invention. All other embodiments obtained by a person of ordinary skill in the art based on the embodiments of the present invention without creative efforts shall fall within the protection scope of the present invention.

With the development and popularization of broadband network technologies, a video on demand technology has been applied to multiple types of terminal devices including various terminal devices with a network access function and a video playing function, such as a computer, a mobile phone, a tablet computer, and a television set. A video file provider may provide, by using a wired or wireless network, a video file stored on a network server to a user using a terminal device for watching. Because of abundant video file resources on the Network, when having no clear target to watch, the user needs to pick out a desired video file by choosing a video file or by using a categorization page.

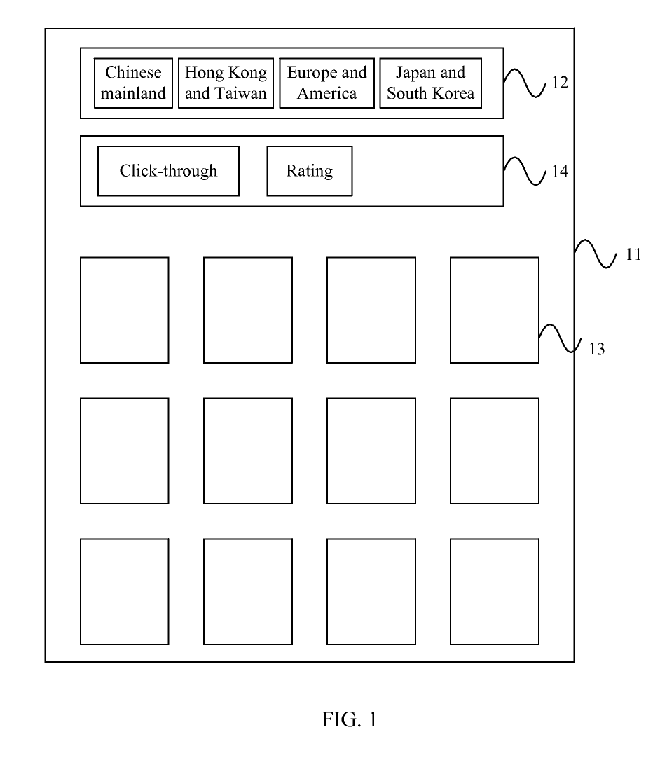

FIG. 1 is a schematic diagram of an existing video on demand page. As shown in FIG. 1, to help a user select an appropriate video file for watching, category tags 12 of a video file is generally provided on a selection page 11 of the video file, and the video file may be categorized from different dimensions by using the category tags 12. For example, if categorized according to a region of a video file, tags such as Chinese mainland, Hong Kong and Taiwan, Europe and America, and Japan and South Korea may be provided in the category tags 12 for the user to select; and if categorized according to a genre of a video file, tags such as comedy, tragedy, horror, and science fiction may be provided in the category tags 12 for the user to select. When the user selects a corresponding option in the category tags 12, video file icons 13 of a corresponding category are displayed on the selection page 11. In addition, sorting tags 14 may further be provided on the selection page 11, and a video file may be sorted from different dimensions by using the sorting tags 14. For example, if sorted according to a click-through rate of a video file, the video file icons 13 are sorted sequentially on the selection page 11 in a high-to-low order by click-through rates of video files; and if sorted according to a rating of a video file, the video file icons 13 are sorted sequentially on the selection page 11 in a high-to-low order by ratings of video files. When the user selects a corresponding option in the sorting tags 14, the video file icons 13 are displayed sequentially on the selection page 11 in a corresponding order. By clicking or tapping a corresponding category tag 12 and a corresponding sorting tag 14, the user may select a video file that the user wants to watch.

The video file provider needs to categorize in advance all video files stores on a server. Therefore, video file icons 13 of the corresponding category can be displayed on the selection page 11 only when the user clicks the corresponding category tag 12. However, a category of a video file is added by the video file provider, and the category reflects only a feeling of the video file provider about the video file. However, people may have different feelings about a same video file. Therefore, the user may be unlikely to pick out a desired video file by using the category added by the video file provider.

In addition, to help the user select a video file, there is generally a brief introduction to a video file below an icon of each video file on the selection page 11 or on a new page displayed upon clicking or tapping the icon of the video file. The introduction relates to information about main content of the video file, comments on the video file, leading actors of the video file, and the like. After learning about the brief introduction to the video file, the user may choose whether to watch the video file. However, an introduction to a video file is also added by the video file provider, and to a great extent, still reflects a feeling of the video file provider about the video file. It is even worse that false introduction information is provided in order to attract the user to watch a video file provided by the video file provider. As a result, the user may be still unlikely to pick out a desired video file.

For the foregoing problems existing in a current video on demand technology, embodiments of the present invention provide a media file marking method: Reaction information of a user generated when the user watches a media file is acquired, and the media file is marked and categorized according to the reaction information of the user, so that the user can quickly pick out a desired media file for watching. When watching the media file, the user unconsciously reveals a true reaction of the user to the media file; therefore, by using the media file marking method provided in the embodiments of the present invention, the user can quickly and accurately select the desired media file.

The media file marking method provided in the embodiments of the present invention relates to a terminal device and a media file server, where the terminal device may be various terminal devices with a wired or wireless network access function and a video playing function, such as a computer, a mobile phone, a tablet computer, and a television set; and the media file server is configured to store a media file and may send, by using a wired or wireless network, the media file to a terminal device of a user for playing.

In addition, it should be noted that in the media file marking method provided in the present invention, the media file is not limited to a video file. The media file marking method provided in the embodiments of the present invention may be applied to any media file that can support a remote on-demand service on the Network, for example, an audio file or the like. The following embodiments of the present invention are described merely by using a video file as an example, but the present invention is not limited thereto.

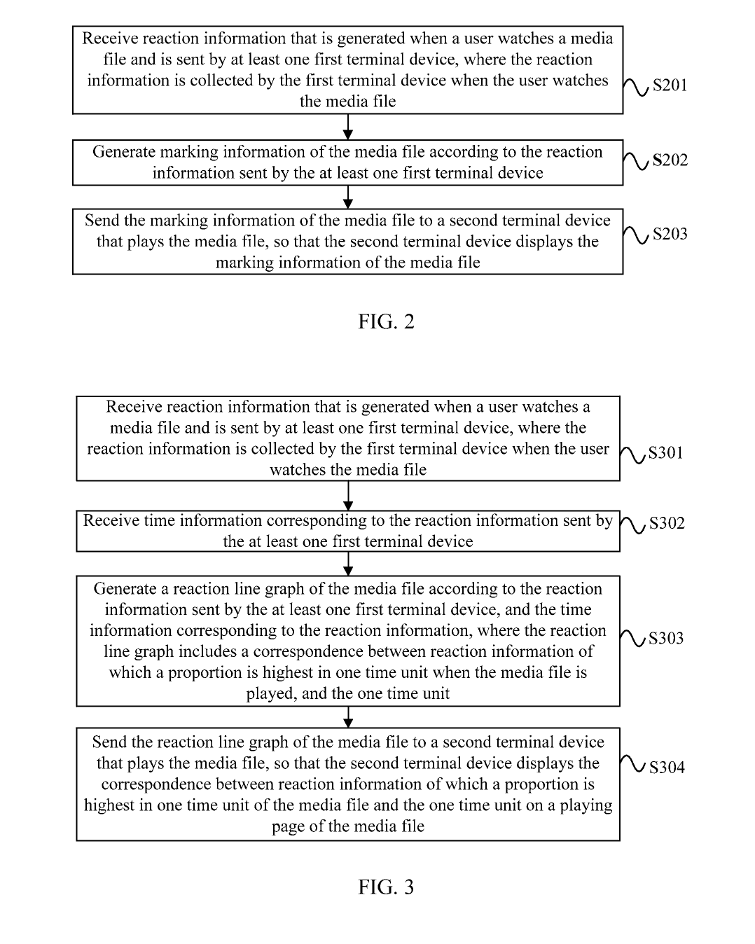

FIG. 2 is a flowchart of Embodiment 1 of a media file marking method according to the present invention. As shown in FIG. 2, the media file marking method in this embodiment includes the following steps:

Step S201: Receive reaction information that is generated when a user watches a media file and is sent by at least one first terminal device, where the reaction information is collected by the first terminal device when the user watches the media file.

Specifically, this embodiment is executed by a media file server on a network. Each type of terminal devices used by the current user for watching the media file is an integrated device that has integrated many functions. In addition to being capable of playing the media file, the terminal device further has a function of acquiring all types of outside information. For example, the terminal device may acquire sound information by using a built-in or peripheral microphone, and can acquire photo or video information by using a built-in or peripheral camera, and some terminal devices may further be connected to a wearable device so as to acquire physiological parameters such as heartbeats, blood pressure of the user. Therefore, when the user watches the media file by using the terminal device, the terminal device may collect information such as sound information, expression information, action information, and physiological information of the user who watches the media file. All the information is a reaction of the user to the media file when the user watches the media file, and therefore the information may be collectively referred to as the reaction information. A terminal device that sends the reaction information to the media file server is referred to as the first terminal device; the media file server may receive the reaction information is generated when the user watches the media file and is sent by the first terminal device; and the media file server may receive, in real time or periodically, the reaction information sent by the first terminal device, and may also receive the reaction information at one time after the user watches the entire media file.

A media file stored on the media file server may be watched by users using any terminal device over a network. The users may show a different reaction when watching a same media file. Therefore, each terminal device on a network may collect different reaction information when the users watch the same media file. The media file server may receive reaction information sent by all first terminal devices on the network, and combine the reaction information generated when the users watch the same media file, so as to generate a reaction information library of the media file.

Step S202: Generate marking information of the media file according to the reaction information sent by the at least one first terminal device.

Specifically, after the media file server receives the reaction information sent by the at least one first terminal device, the media file server may identify the received reaction information to obtain a user state represented by each piece of the reaction information of the user. For example, by using the reaction information such as a sound and a video, it may be identified that the user who watches the media file is in a state of crying, laughing, being frightened, or the like. After the received reaction information is identified, proportions of different states that the user shows when watching the media file are counted, and the marking information of the media file may be generated according to the proportions. The marking information of the media file may include a category identifier of the media file or a reaction line graph of the media file, where the category identifier of the media file indicates a genre corresponding to the media file, such as tragedy, comedy, or horror; and the reaction line graph of the media file indicates a correspondence between reaction information of which a proportion is highest in one time unit when the media file is played and the time unit. To sum up, the marking information of the media file is various parameters that may characterize information related to the media file.

Step S203: Send the marking information of the media file to a second terminal device that plays the media file, so that the second terminal device displays the marking information of the media file.

Specifically, a terminal device that receives the marking information sent by the media file server is referred to as a second terminal device; after generating the marking information of the media file, the media file server sends the marking information of the media file to the second terminal device. In this case, when the user watches the media file by using the second terminal device, the second terminal device may display the marking information, so that the user who watches the media file can learn the information related to the media file according to the marking information. The marking information is generated by acquiring reaction information of users who watch the media file. Therefore, the marking information of the media file reflects true feelings of other users about the media file. If the media file server receives the reaction information from more first terminal devices, the marking information sent by the media file server to the second terminal device that plays the media file is more likely to reflect true feelings of most users about the media file, thereby further increasing reliability of the marking information of the media file. The user selects a media file according to the marking information of the media file, which improves accuracy for selection.

The foregoing first terminal device and second terminal device may be any terminal devices on the network, and the first terminal device may be the same as or different from the second terminal device.

In this embodiment, reaction information of a user generated when the user watches a media file is acquired, and the media file is marked and categorized according to reaction information of all users who watch the media file over a network, so that the user can quickly pick out a desired media file for watching, thereby enabling the user to quickly and accurately pick out the desired media file.

Further, in the embodiment shown in FIG. 2, the marking information of the media file includes the category identifier of the media file or the reaction line graph of the media file. When the marking information of the media file is the category identifier of the media file, in the media file marking method shown in FIG. 2, step S202 may specifically include: generating a category identifier of the media file according to the reaction information sent by the at least one first terminal device. Specifically, category identifiers, which correspond to different user states, of media files are preset on the media file server, for example, “crying” corresponds to a tragedy movie, “laughing” corresponds to a comedy movie, and “being frightened” corresponds to a horror movie. The media file server may use a category identifier of a media file corresponding to reaction information of which a proportion is highest in the received reaction information as the category identifier of the media file, or may use a category identifier of a media file corresponding to reaction information of which the proportion is higher than a preset threshold in the received reaction information as the category identifier of the media file. That is, the media file may have more than one category identifier, for example, the media file may be both a comedy movie and a horror movie. Step S203 may specifically include: sending the category identifier of the media file to the second terminal device that plays the media file, so that the second terminal device displays the category identifier of the media file on a display page or in the user interface of the media file. Specifically, the display page of the media file is a page for displaying basic information about the media file; the user selects, on the display page of the media file, a media file that the user wants to watch; and the category identifier of the media file is displayed on the display page of the media file, and the user can learn a genre of the media file according to the category identifier of the media file. Further, the user may categorize media files on a search page of media files according to the category identifier of the media file, and sort the media files according to a proportion of users for the same category identifier. The media file server may send, upon generating the category identifier of the media file, the category identifier to the second terminal device, or may send the category identifier to the second terminal device when the second terminal device needs to display the media file on the display page.

FIG. 3 is a flowchart of Embodiment 2 of a media file marking method according to the present invention. As shown in FIG. 3, the media file marking method in this embodiment includes the following steps:

Step S301: Receive reaction information that is generated when a user watches a media file and is sent by at least one first terminal device, where the reaction information is collected by the first terminal device when the user watches the media file.

Step S302: Receive time information corresponding to the reaction information sent by the at least one first terminal device.

Specifically, when watching the media file by using a terminal device, the user may choose to fast forward and skip a dilatory part of a story. In this case, however, the user may miss a key plot point or an infectious plot point of the media file. Therefore, while acquiring the reaction information generated when the user watches the media file, the terminal device further acquires the time information of the reaction information. In this way, the media file server can receive the reaction information that is generated when the user watches the media file and is sent by the first terminal device, and the time information corresponding to the reaction information generated when the user watches the media file.

It should be noted that step S301 and step S302 may be performed simultaneously.

Step S303: Generate a reaction line graph of the media file according to the reaction information sent by the at least one first terminal device, and the time information corresponding to the reaction information, where the reaction line graph includes a correspondence between reaction information of which a proportion is highest in one time unit when the media file is played, and the one time unit.

Specifically, according to the received reaction information, and the time information corresponding to the reaction information, the media file server may obtain a variation relationship between the reaction information, and the time information corresponding to the reaction information. By using the reaction information as a vertical coordinate, and the time information corresponding to the reaction information as a horizontal coordinate, the reaction line graph of the media file is generated. The reaction line graph of the media file includes the correspondence between reaction information of which a proportion is highest in one time unit when the media file is played, and the one time unit. The reaction line graph of the media file indicates a correspondence between a reaction, to the media file, of the user who watches the media file and a time point when the reaction occurs. When most users have a same or similar reaction to the media file at a time point, it indicates that the media file has corresponding appeal to most users at the time point. Generally, the time point is the key plot point of the media file. Therefore, the reaction line graph of the media file indicates a reaction condition of the user to the media file in a process in which the user watches the entire media file. Different people may have different reactions when watching a same media file, but generally, most people have a same reaction to a same plot. For example, when an actor tells a joke in a movie, most people burst out laughing or shows a smiling expression. Therefore, same reaction information of which the proportion is highest in one time unit when the media file is played indicates what a key plot of the media file in the time is. A higher proportion indicates that more users are infected by the plot. This moment is the key plot point of the media file. Therefore, the reaction line graph of the media file may use time of the media file as the horizontal axis, and a proportion of a same reaction of users appearing in a same time as the ordinate axis, so that a plot variation of the media file may be represented by using the reaction line graph.

Step S304: Send the reaction line graph of the media file to a second terminal device that plays the media file, so that the second terminal device displays the correspondence between reaction information of which a proportion is highest in one time unit of the media file and the one time unit on a playing page of the media file.

Specifically, the media file server sends the generated reaction line graph to the second terminal device. In this case, in a process in which the user watches the media file by using the second terminal device, the reaction line graph may be displayed on the playing page of the media file. According to the reaction line graph, the user may learn a time point of the media file at which the key plot point appears. In this case, in the process of watching the media file, the user would not miss the key plot point. The media file server may send, upon generating the reaction line graph of the media file, the reaction line graph to the second terminal device, or may send the reaction line graph to the second terminal device when the second terminal device needs to play the media file on the playing page.

It should be noted that generating the reaction line graph of the media file according to the reaction information of the user and displaying the reaction line graph on the playing page of the media file are merely illustrated in the method provided in this embodiment. However, according to the media file marking method provided in the present invention, both a category identifier and the reaction line graph of the media file may be further generated according to the reaction information of the user, and the category identifier and the reaction line graph are displayed respectively on a display page or in the user interface and the playing page of the media file according to a requirement.

In this embodiment, reaction information of a user, and time information corresponding to the reaction information are acquired when the user watches a media file; the media file is marked and categorized according to reaction information of all users who watch the media file on a network; and a reaction line graph of the media file is generated, so that the user can quickly pick out a desired media file for watching. In addition, the user may learn a key plot point of the media file, thereby enabling the user to quickly and accurately pick out the desired media file without missing the key plot point of the media file.

Further, in the embodiment shown in FIG. 3, the reaction line graph of the media file generated by the media file server includes the correspondence between reaction information of which a proportion is highest in one time unit when the media file is played, and the one time unit, that is, in each time unit of the media file on the reaction line graph, there is a piece of reaction information of which a proportion is highest. However, such a reaction line graph is over informative. Generally, the user who watches the media file does not need to learn reactions at each time unit when other users watch the media file, but only needs to learn the reactions of other users to the key plot point of the media file. Therefore, the reaction line graph of the media file further includes reaction information of which a proportion is highest in one time unit and the proportion is higher than a preset threshold. That is, the reaction information is marked up in the time unit on the reaction line graph of the media file only when the proportion of the reaction information in the one time unit is higher than a preset threshold.

For example, in one time unit of the media file, if more than 70% of the received reaction information of the media file is “laughing”, the reaction information of which the proportion is highest in this time unit is “laughing”; in another time unit of the media file, if 35% of the received reaction information of the media file is “laughing” and another 35% is “crying”, the reaction information of which the proportion is highest in this time unit is “laughing” and “crying”. If the preset proportion threshold is set to 50%, on the reaction line graph of the media file, only the “laughing” reaction information is displayed in the time unit in which more than 70% of the reaction information is “laughing”, but the reaction information in the time unit in which 35% is “laughing” and another 35% is “crying” is not displayed.

On the reaction line graph, the second terminal device may display only a representative icon of the reaction information of which the proportion is highest in the one time unit or the proportion is higher than the preset threshold, and may also display representative reaction information of the user, such as a photo or a video. The user who watches the media file may click the representative icon, on the reaction line graph, of the reaction information of which the proportion is highest or the proportion is higher than the preset threshold, so as to see specific reactions when other users watch the media file. Meanwhile, the user may further perform an operation such as commenting on or forwarding reaction information of other users, so that much fun may be added when the user watches the video file.

In addition, the following may be set actively by the user or according to a preset mechanism: only the reaction line graph of the media file is displayed but the reaction information, of the reaction line graph, of which the proportion is highest or the proportion higher than the preset threshold is not displayed on the playing page of the media file. The reaction information of which the proportion is highest or the proportion is higher than the threshold is displayed only by using a setting or by clicking or tapping a switch when the user needs to watch the reaction information on the reaction line graph. In this way, the following situation may be avoided: reaction information of other users at each time point of the media file is known too early by the user, and therefore pleasure of watching the media file by the user is reduced.

Further, after the reaction line graph of the media file is generated, a category identifier corresponding to the reaction information of which the proportion is highest in one time unit and the proportion is higher than the preset threshold may be further used as the category identifier of the media file.

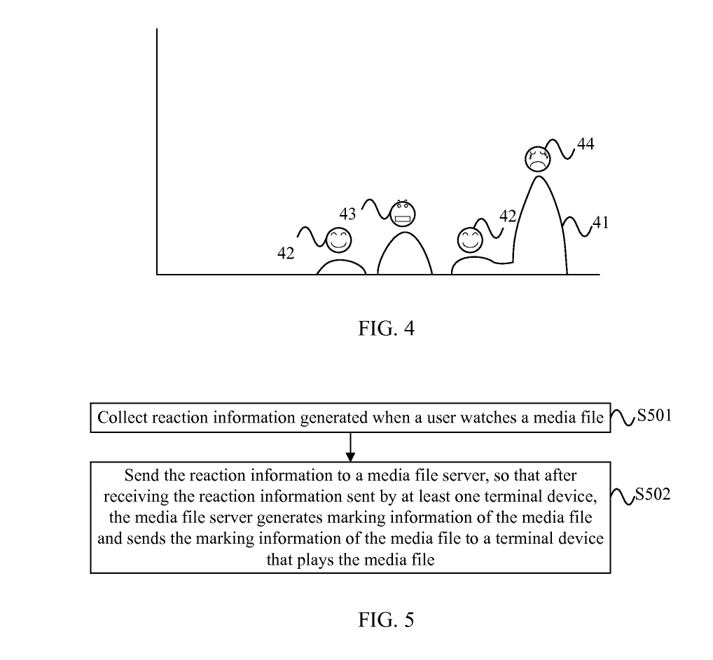

FIG. 4 is a schematic diagram of a reaction line graph of a media file. As shown in FIG. 4, the horizontal axis represents time of the media file, and the ordinate axis represents a proportion of a same reaction of users at a same time point; a curve 41 represents the reaction line graph of the media file, an icon corresponding to same reaction information is marked up or the reaction information is marked up directly at a time point when same reaction information of which the proportion is higher than a threshold appears. In the graph, a “happy” icon 42 is marked up at a first time point at which the proportion is higher than the preset threshold; a “frightened” icon 43 is marked up at a second time point at which the proportion is higher than the preset threshold; the “happy” icon 42 is marked up at a third time point at which the proportion is higher than the preset threshold; and a “sad” icon 44 is marked up at a fourth time point at which the proportion is higher than the preset threshold. It may be seen from the curve 41 that each peak of the curve 41 represents an emotional infection point, a width of the peak represents an infection duration, a height of the peak represents infection strength, and a position of the peak represents a time point of the infection.

Further, in the embodiments shown in FIG. 2 and FIG. 3, the reaction information of the user may include at least one of the following: sound information, expression information, action information, and physiological information. There are a wide range of types of terminal devices used by users to watch a media file, and there are also a great many built-in or peripheral devices that collect reaction information and can be supported by the terminal devices. Therefore, any terminal device including at least one device that can collect the reaction information and can send the collected reaction information to a media file server shall fall within the protection scope of the present invention. For example, a device such as a mobile phone, a computer, or a tablet computer has a microphone and/or a camera, and therefore may collect sound information and/or expression information; a television remote controller with a microphone can collect sound information; and a device, such as a smartwatch or smartglasses, that can be connected to a device such as a mobile phone or a computer can collect physiological information of a user, such as blood pressure and heartbeats.

It should be noted that both the first terminal device and the second terminal device in the embodiments shown in FIG. 2 and FIG. 3 is any terminal devices on a network. A terminal device that collects reaction information and sends the reaction information to the media file server is referred to as the first terminal device, and a terminal device that receives marking information sent by the media file server and plays the media file is referred to as the second terminal device. The first terminal device and the second terminal device may also be the same terminal device.

FIG. 5 is a flowchart of Embodiment 3 of a media file marking method according to the present invention. As shown in FIG. 5, the media file marking method in this embodiment includes:

Step S501: Collect reaction information generated when a user watches a media file.

Specifically, this embodiment is executed by a terminal device used by the user for watching the media file. Each type of terminal devices used by a current user for watching the media file is an integrated device that has integrated many functions. In addition to being capable of playing the media file, the terminal device further has a function of acquiring all types of external information. For example, the terminal device may acquire sound information by using a built-in or peripheral microphone, and acquire photo or video information by using a built-in or peripheral camera, and some terminal devices may further be connected to a wearable device so as to acquire physiological parameters such as heartbeats, blood pressure of the user. Therefore, when the user watches the media file by using the terminal device, the terminal device may collect information such as sound information, expression information, action information, and physiological information of the user who watches the media file. All the foregoing information is a reaction when the user watches the media file, and therefore the foregoing information may be collectively referred to as the reaction information.

Step S502: Send the reaction information to a media file server, so that after receiving the reaction information sent by at least one terminal device, the media file server generates marking information of the media file and sends the marking information of the media file to a terminal device that plays the media file.

Specifically, after collecting the reaction information of the user who watches the media file, the terminal device sends the reaction information to the media file server; and the terminal device may send the reaction information to the media file server in real time or periodically, or may send the reaction information at one time after the user watches the entire media file. A media file stored on the media file server may be watched by users using any terminal device over a network. Each user may show a different reaction when watching a same media file. Therefore, each terminal device on a network may collect different reaction information when the users watches the same media file. After receiving the reaction information sent by the at least one terminal device, the media file server generates the marking information of the media file according to the reaction information.

The marking information of the media file generated by the media file server indicates a true reaction, to the media file, of the user who watches the media file. The media file server may identify the reaction information to obtain a user state indicated by each piece of the reaction information of the user. For example, by using the reaction information such as a sound and a video, it may be identified that the user who watches the media file is in a state of crying, laughing, being frightened, or the like. After the reaction information is identified, proportions of different states that the user shows when watching the media file are counted, and the marking information of the media file may be generated according to the proportions. The marking information of the media file may include a category identifier of the media file or a reaction line graph of the media file, where the category identifier of the media file indicates a genre corresponding to the media file, such as tragedy, comedy, or horror; and the reaction line graph of the media file indicates a correspondence between reaction information of which a proportion is highest in one time unit when the media file is played, and the time unit. To sum up, the marking information of the media file is various parameters that may characterize information related to the media file.

The media file server sends the generated marking information of the media file to the terminal device that plays the media file; after the terminal device that plays the media file receives the marking information of the media file and when the user watches the media file by using the terminal device, the terminal device displays the marking information on a corresponding page, so that the user who watches the media file can learn the information related to the media file according to the marking information. The marking information is generated by acquiring reaction information of all users who watch the media file. Therefore, the marking information of the media file reflects true feelings of other users about the media file. If the media file server receives the reaction information from more terminal devices, the marking information sent by the media file server to the terminal device that plays the media file is more likely to reflect true feelings of most users about the media file, thereby further increasing reliability of the marking information of the media file. The user selects a media file according to the marking information of the media file, which improves accuracy for selection.

In this embodiment, reaction information of a user is acquired when the user watches a media file, and the media file is marked and categorized according to reaction information of all users who watch the media file over a network, so that the user can quickly pick out a desired media file for watching, thereby enabling the user to quickly and accurately pick out the desired media file.

Further, in the embodiment shown in FIG. 5, the marking information of the media file includes the category identifier of the media file or the reaction line graph of the media file. When the marking information of the media file is the category identifier of the media file, in the media file marking method shown in FIG. 5, step S502 may specifically include: sending the reaction information to the media file server, so that after receiving the reaction information sent by the at least one terminal device, the media file server generates the category identifier of the media file and sends the category identifier of the media file to the terminal device that plays the media file. Category identifiers, which correspond to different user states, of media files are preset on the media file server, for example, “crying” corresponds to a tragedy movie, “laughing” corresponds to a comedy movie, and “being frightened” corresponds to a horror movie. The media file server may use a category identifier of a media file corresponding to reaction information of which a proportion is highest in the received reaction information as the category identifier of the media file, or may use a category identifier of a media file corresponding to reaction information of which the proportion is higher than a preset threshold in the received reaction information as the category identifier of the media file. That is, the media file may have more than one category identifier, for example, the media file may be both a comedy movie and a horror movie. After the media file server generates the category identifier of the media file, the terminal device may receive the category identifier sent by the media file server. The media file server may send, upon generating the category identifier of the media file, the category identifier to the terminal device that plays the media file, or may send the category identifier to the terminal device when the terminal device that plays the media file needs to display the media file on a display page or in the user interface.

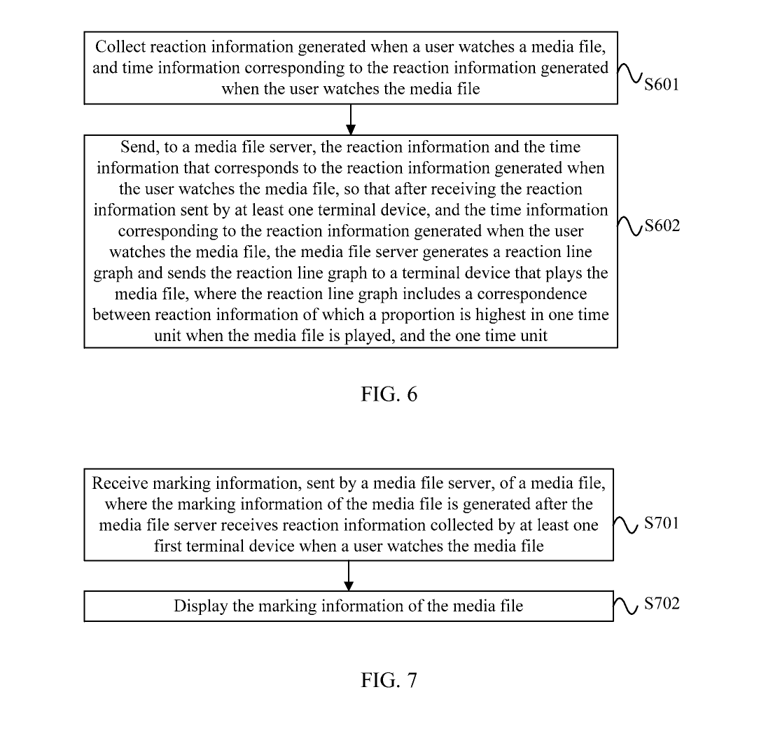

FIG. 6 is a flowchart of Embodiment 4 of a media file marking method according to the present invention. As shown in FIG. 6, the media file marking method in this embodiment includes the following steps:

Step S601: Collect reaction information generated when a user watches a media file, and time information corresponding to the reaction information generated when the user watches the media file.

Specifically, when watching the media file by using a terminal device, the user may choose to fast forward and skip a dilatory part of a story. In this case, however, the user may miss a key plot point or an infectious plot point of the media file. Therefore, while acquiring the reaction information generated when the user watches the media file, the terminal device further acquires the time information of the reaction information.

Step S602: Send, to a media file server, the reaction information and the time information that corresponds to the reaction information generated when the user watches the media file, so that after receiving the reaction information sent by at least one terminal device, and the time information corresponding to the reaction information generated when the user watches the media file, the media file server generates a reaction line graph and sends the reaction line graph to a terminal device that plays the media file, where the reaction line graph includes a correspondence between reaction information of which a proportion is highest in one time unit when the media file is played, and the one time unit.

Specifically, the terminal device sends, to the media file server, the reaction information generated when the user watches the media file, and the time information corresponding to the reaction information; after receiving the reaction information of the media file sent by the at least one terminal device, and the time information corresponding to the reaction information generated when the user watches the media file, the media file server may obtain a variation relationship between the reaction information and the time information corresponding to the reaction information according to the received reaction information and the time information corresponding to the reaction information. By using the reaction information as a vertical coordinate, and the time information corresponding to the reaction information as a horizontal coordinate, the reaction line graph of the media file is generated. The reaction line graph of the media file includes the correspondence between reaction information of which a proportion is highest in one time unit when the media file is played, and the one time unit. The reaction line graph of the media file indicates a correspondence between a reaction, to the media file, of the user who watches the media file and a time point when the reaction occurs. When most users have a same or similar reaction to the media file at a time point, it indicates that the media file has corresponding appeal to most users at the time point. Generally, the time point is the key plot point of the media file. Therefore, the reaction line graph of the media file indicates a reaction condition of the user to the media file in a process in which the user watches the entire media file. Different people may have different reactions when watching a same media file, but generally, most people have a same reaction to a same plot. For example, when an actor tells a joke in a movie, most people burst out laughing or shows a smiling expression. Therefore, same reaction information of which the proportion is highest in one time unit when the media file is played indicates what a key plot of the media file in the time is. A higher proportion indicates that more users are infected by the plot. This moment is the key plot point of the media file. Therefore, the reaction line graph of the media file may use time of the media file as the horizontal axis, and a proportion of a same reaction of users appearing at a same time as the ordinate axis, so that a plot variation of the media file may be represented by using the reaction line graph.

The media file server sends the generated reaction line graph of the media file to the terminal device that plays the media file; after the terminal device that plays the media file receives the reaction line graph of the media file, in a process in which the user watches the media file by using the terminal device, the reaction line graph is displayed on a playing page of the media file. According to the reaction line graph, the user may learn a time point of the media file at which the key plot point appears. In this case, in the process of watching the media file, the user would not miss the key plot point. The media file server may send, upon generating the reaction line graph of the media file, the reaction line graph to the terminal device that plays the media file, or may send the reaction line graph to the terminal device when the terminal device that plays the media file needs to play the media file on the playing page.

It should be noted that generating the reaction line graph of the media file according to the reaction information of the user and displaying the reaction line graph on the playing page of the media file are merely illustrated in the method provided in this embodiment. However, according to the media file marking method provided in the present invention, both a category identifier and the reaction line graph of the media file may further be generated according to the reaction information of the user, and the category identifier and the reaction line graph are displayed respectively on a display page or in the user interface and the playing page of the media file according to a requirement.

In this embodiment, reaction information of a user, and time information corresponding to the reaction information are acquired when the user watches a media file; the media file is marked and categorized according to reaction information of all users who watch the media file on a network; and a reaction line graph of the media file is generated, so that the user can quickly pick out a desired media file for watching. In addition, the user may learn a key plot point of the media file, thereby enabling the user to quickly and accurately pick out the desired media file without missing the key plot point of the media file.

Further, in the embodiments shown in FIG. 5 and FIG. 6, the collecting reaction information generated when a user watches a media file includes collecting, by using a peripheral device, the reaction information generated when the user watches the media file, where the peripheral device includes at least one of the following: a voice collecting device, a video collecting device, and a physiology collecting device; and the reaction information of the user may include at least one of the following: sound information, expression information, action information, and physiological information. There are a wide range of types of terminal devices used by users to watch a media file, and there are also a great many built-in or peripheral devices that collect reaction information and can be supported by the terminal devices. Therefore, any terminal device including at least one device that can collect reaction information and can send the collected reaction information to a media file server shall fall within the protection scope of the present invention. For example, a device such as a mobile phone, a computer, or a tablet computer has a microphone and/or a camera, and therefore may collect sound information and/or expression information; a television remote controller with a microphone can collect sound information; and a device, such as a smartwatch or smartglasses, that can be connected to a device such as a mobile phone or a computer can collect physiological information of a user, such as blood pressure and heartbeats.

It should be noted that the embodiments shown in FIG. 5 and FIG. 6 are executed by the terminal device, which may correspond to the first terminal device in the embodiments shown in FIG. 2 and FIG. 3.

FIG. 7 is a flowchart of Embodiment 5 of a media file marking method according to an embodiment of the present invention. As shown in FIG. 7, the media file marking method in this embodiment includes the following steps:

Step S701: Receive marking information, sent by a media file server, of a media file, where the marking information of the media file is generated after the media file server receives reaction information collected by at least one first terminal device when a user watches the media file.

Specifically, this embodiment is executed by a terminal device used by the user for watching the media file, where the terminal device may correspond to the second terminal device in the embodiment shown in FIG. 2. The terminal device can receive the marking information, sent by the media file server, of the media file, where the marking information of the media file is generated after the media file server receives the reaction information collected by the at least one first terminal device when the user watches the media file. The first terminal device may collect and report the reaction information according to the method in the embodiment shown in FIG. 5 or FIG. 6, and details are not described herein again.

The marking information of the media file generated by the media file server indicates a true reaction, to the media file, of the user who watches the media file. The media file server may identify the reaction information to obtain a user state indicated by each piece of the reaction information of the user. For example, by using the reaction information such as a sound and a video, it may be identified that the user who watches the media file is in a state of crying, laughing, being frightened, or the like. After the reaction information is identified, proportions of different states that the user shows when watching the media file are counted, and the marking information of the media file may be generated according to the proportions. The marking information of the media file may include a category identifier of the media file or a reaction line graph of the media file, where the category identifier of the media file indicates a genre corresponding to the media file, such as tragedy, comedy, or horror; and the reaction line graph of the media file indicates a correspondence between reaction information of which a proportion is highest in one time unit when the media file is played, and the time unit. To sum up, the marking information of the media file is various parameters that may characterize information related to the media file.

Step S702: Display the marking information of the media file.

Specifically, after the terminal device receives the marking information of the media file and when the user watches the media file by using the terminal device, the terminal device displays the marking information of the media file on a corresponding page, so that the user who watches the media file can learn the information related to the media file according to the marking information. The marking information is generated by acquiring reaction information of all users who watch the media file. Therefore, the marking information of the media file reflects true feelings of other users about the media file. If the media file server receives the reaction information from more terminal devices, the marking information sent by the media file server to the terminal device that plays the media file is more likely to reflect true feelings of most users about the media file, thereby further increasing reliability of the marking information of the media file. The user selects a media file according to the marking information of the media file, which improves accuracy for selection.

In this embodiment, reaction information of a user is acquired when the user watches a media file, and the media file is marked and categorized according to reaction information of all users who watch the media file over a network, so that the user can quickly pick out a desired media file for watching, thereby enabling the user to quickly and accurately pick out the desired media file.

Further, in the embodiment shown in FIG. 7, the marking information of the media file includes the category identifier of the media file or the reaction line graph of the media file. When the marking information of the media file is the category identifier of the media file, in the media file marking method shown in FIG. 7, step S701 may specifically include: receiving a category identifier, sent by the media file server, of the media file, where the category identifier of the media file is generated after the media file server receives the reaction information collected by the at least one first terminal device when the user watches the media file. Category identifiers, which correspond to different user states, of media files are preset on the media file server, for example, “crying” corresponds to a tragedy movie, “laughing” corresponds to a comedy movie, and “being frightened” corresponds to a horror movie. The media file server may use a category identifier of a media file corresponding to reaction information of which a proportion is highest in the received reaction information as the category identifier of the media file, or may use a category identifier of a media file corresponding to reaction information of which the proportion is higher than a preset threshold in the received reaction information as the category identifier of the media file. That is, the media file may have more than one category identifier, for example, the media file may be both a comedy movie and a horror movie. After the media file server generates the category identifier of the media file, the terminal device may receive the category identifier sent by the media file server. The media file server may send, upon generating the marking information of the media file, the category identifier to the terminal device, or may send the category identifier to the terminal device when the terminal device needs to display the media file on a display page or in the user interface. Step S702 may specifically include: displaying the category identifier of the media file on a display page or in the user interface of the media file. Specifically, the display page of the media file is a page for displaying basic information about the media file; the user selects, on the display page of the media file, a media file that the user wants to watch; and the category identifier of the media file is displayed on the display page of the media file, and the user can learn a genre of the media file according to the category identifier of the media file. Further, the user may categorize media files on a search page of media files according to the category identifier of the media file, and sort the media files according to a proportion of users for the same category identifier. The media file server may send, upon generating the category identifier of the media file, the category identifier to the terminal device, or may send the category identifier to the terminal device when the terminal device needs to display the media file on the display page.

Further, in the embodiment shown in FIG. 7, when the marking information of the media file is the reaction line graph of the media file, in the media file marking method shown in FIG. 7, step S701 may specifically include: receiving a reaction line graph, sent by the media file server, of the media file, where the reaction line graph of the media file is generated after the media file server receives the reaction information collected by the at least one first terminal device when the user watches the media file, and time information corresponding to the reaction information generated when the user watches the media file, where the reaction line graph includes a correspondence between reaction information of which a proportion is highest in one time unit when the media file is played, and the one time unit. According to the received reaction information and the time information corresponding to the reaction information, the media file server may obtain a variation relationship between the reaction information and the time information corresponding to the reaction information. By using the reaction information as a vertical coordinate, and the time information corresponding to the reaction information as a horizontal coordinate, the reaction line graph of the media file is generated. The reaction line graph of the media file includes the correspondence between reaction information of which a proportion is highest in one time unit when the media file is played, and the one time unit. The reaction line graph of the media file indicates a correspondence between a reaction, to the media file, of the user who watches the media file and a time point when the reaction occurs. When most users have a same or similar reaction to the media file at a time point, it indicates that the media file has corresponding appeal to most users at the time point. Generally, the time point is a key plot point of the media file. Therefore, the reaction line graph of the media file indicates a reaction condition of the user to the media file in a process in which the user watches the entire media file. Different people may have different reactions when watching a same media file, but generally, most people have a same reaction to a same plot. For example, when an actor tells a joke in a movie, most people burst out laughing or shows a smiling expression. Therefore, same reaction information of which the proportion is highest in one time unit when the media file is played indicates what a key plot of the media file in the time is. A higher proportion indicates that more users are infected by the plot. This moment is the key plot point of the media file. Therefore, the reaction line graph of the media file may use time of the media file as the horizontal axis, and a proportion of a same reaction of users appearing in a same time as the ordinate axis, so that a plot variation of the media file may be represented by using the reaction line graph. Step S702 may specifically include: displaying a correspondence between reaction information of which a proportion is highest in one time unit of the media file and the time unit on a playing page of the media file. Specifically, after the terminal device receives the reaction line graph of the media file, in a process in which the user watches the media file by using the terminal device, the reaction line graph is displayed on the playing page of the media file. According to the reaction line graph, the user may learn a time point of the media file at which the key plot point appears. In this case, in the process of watching the media file, the user would not miss the key plot point. The media file server may send, upon generating the reaction line graph of the media file, the reaction line graph to the terminal device that plays the media file, or may send the reaction line graph to the terminal device when the terminal device that plays the media file needs to play the media file on the playing page.

Further, in the embodiment shown in FIG. 7, the reaction line graph of the media file generated by the media file server includes the correspondence between reaction information of which a proportion is highest in one time unit when the media file is played, and the one time unit, that is, in each time unit of the media file on the reaction line graph, there is a piece of reaction information of which a proportion is highest. However, such a reaction line graph is over informative. Generally, the user who watches the media file does not need to learn reactions at each time unit when other users watch the media file, but only needs to learn the reactions of other users to the key plot point of the media file. Therefore, the reaction line graph of the media file further includes reaction information of which a proportion is highest in one time unit and the proportion is higher than a preset threshold. That is, the reaction information is marked up in the time unit on the reaction line graph of the media file only when the proportion of the reaction information in the one time unit is higher than a preset threshold.

For example, in one time unit of the media file, if more than 70% of the received reaction information of the media file is “laughing”, the reaction information of which the proportion is highest in this time unit is “laughing”; in another time unit of the media file, if 35% of the received reaction information of the media file is “laughing” and another 35% is “crying”, the reaction information of which the proportion is highest in this time unit is “laughing” and “crying”. If the preset proportion threshold is set to 50%, on the reaction line graph of the media file, only the “laughing” reaction information is displayed in the time unit in which more than 70% of the reaction information is “laughing”, but the reaction information in the time unit in which 35% is “laughing” and another 35% is “crying” is not displayed.

The reaction information of which the proportion is highest in the one time unit and the proportion is higher than the preset threshold is displayed on a corresponding position of the reaction line graph on the playing page of the media file.

On the reaction line graph, the terminal device may display only a representative icon of the reaction information of which the proportion is highest in the one time unit and the proportion is higher than the preset threshold, and may also display representative reaction information of the user, such as a photo or a video. The user who watches the media file may click the representative icon, on the reaction line graph, of the reaction information of which the proportion is highest or the proportion is higher than the preset threshold, so as to see specific reactions when other users watch the media file. Meanwhile, the user may further perform an operation such as commenting on or forwarding reaction information of other users, so that much fun may be added when the user watches the video file.

In addition, the following may be set actively by the user or according to a preset mechanism: only the reaction line graph of the media file is displayed but the reaction information, of the reaction line graph, of which the proportion is highest or the proportion higher than the preset threshold is not displayed on the playing page of the media file. The reaction information of which the proportion is highest or the proportion is higher than the threshold is displayed only by using a setting or by clicking or tapping a switch when the user needs to watch the reaction information on the reaction line graph. In this way, the following situation may be avoided: reaction information of other users at each time point of the media file is known too early by the user, and therefore pleasure of watching the media file by the user is reduced.

Further, in the embodiment shown in FIG. 7, if the marking information of the media file is the reaction line graph of the media file, the displaying the marking information of the media file further includes: displaying the category identifier of the media file on the display page of the media file, where the category identifier of the media file is a category identifier corresponding to the reaction information of which the proportion is highest in the one time unit and higher than the preset threshold.

It should be noted that the embodiment shown in FIG. 7 is executed by the terminal device, which may correspond to the second terminal device in the embodiment shown in FIG. 2 or FIG. 3.

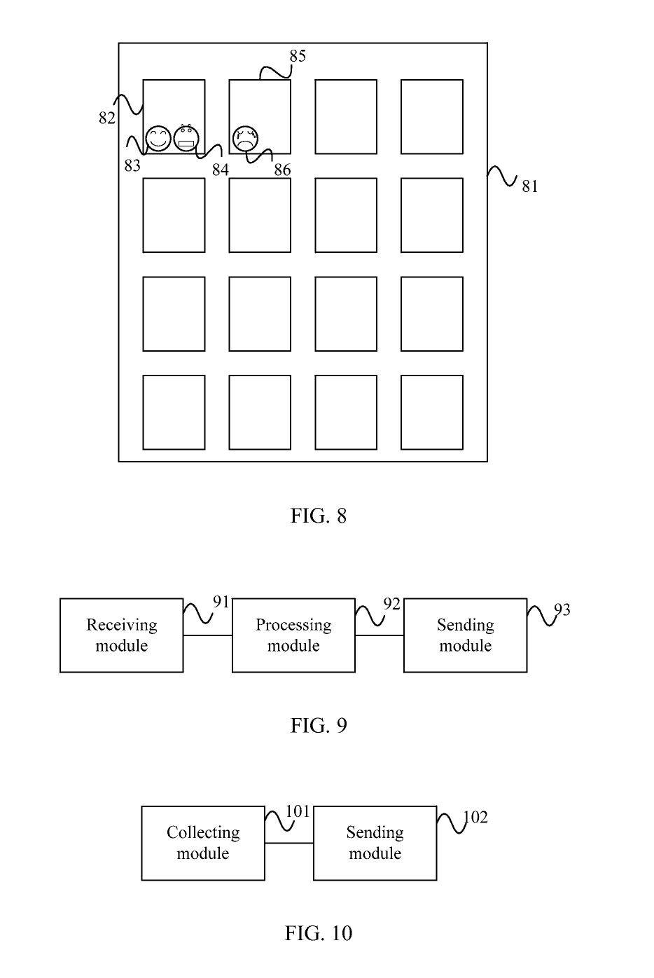

FIG. 8 is a schematic diagram of a display page of a media file according to the present invention. As shown in FIG. 8, after a media file marking method provided in the embodiments of the present invention is used, on the display page 81 of the media file, a category identifier of each media file may be displayed in an icon area of the media file. For example, if category identifiers of a media file 82 are “comedy” and “horror”, a “happy” icon 83 and a “frightened” icon 84 are displayed in an icon area of the media file 82; if a category identifier of a media file 85 is “tragedy”, a “sad” icon 86 is displayed in an icon area of the media file 85; and the like.

FIG. 9 is a schematic structural diagram of Embodiment 1 of a media file server according to an embodiment of the present invention. As shown in FIG. 9, the media file server in this embodiment includes:

a receiving module 91, configured to receive reaction information that is generated when a user watches a media file and is sent by at least one first terminal device, where the reaction information is collected by the first terminal device when the user watches the media file;

a processing module 92, configured to generate marking information of the media file according to the reaction information sent by the at least one first terminal device; and

a sending module 93, configured to send the marking information of the media file to a second terminal device that plays the media file, so that the second terminal device displays the marking information of the media file.

The media file server in this embodiment is configured to execute a technical solution of the method embodiment shown in FIG. 2, and implementation principles and technical effects of the media file server are similar and are not described herein again.

Further, in the embodiment shown in FIG. 9, the marking information of the media file includes a category identifier of the media file; the processing module 92 is specifically configured to generate the category identifier of the media file according to the reaction information sent by the at least one first terminal device; and the sending module 93 is specifically configured to send the category identifier of the media file to the second terminal device that plays the media file, so that the second terminal device displays the category identifier of the media file on a display page or in the user interface of the media file.

Further, in the embodiment shown in FIG. 9, the marking information of the media file includes a reaction line graph of the media file; the receiving module 91 is further configured to receive time information corresponding to the reaction information sent by the at least one first terminal device; the processing module 92 is specifically configured to generate the reaction line graph according to the reaction information sent by the at least one first terminal device, and the time information corresponding to the reaction information, where the reaction line graph includes a correspondence between reaction information of which a proportion is highest in one time unit when the media file is played, and the one time unit; and the sending module 93 is specifically configured to send the reaction line graph of the media file to the second terminal device that plays the media file, so that the second terminal device displays the correspondence between reaction information of which a proportion is highest in one time unit of the media file and the one time unit on a playing page of the media file.

Further, in the embodiment shown in FIG. 9, the processing module 92 is further configured to use a category identifier corresponding to the reaction information of which the proportion is highest in the one time unit and the proportion is higher than a preset threshold as the category identifier of the media file; and the sending module 93 is specifically configured to send the category identifier of the media file to the second terminal device that plays the media file, so that the second terminal device displays the category identifier of the media file.

Further, in the embodiment shown in FIG. 9, the reaction information includes at least one of the following: sound information, expression information, action information, and physiological information.

FIG. 10 is a schematic structural diagram of Embodiment 1 of a terminal device according to an embodiment of the present invention. As shown in FIG. 10, the terminal device in this embodiment includes:

a collecting module 101, configured to collect reaction information generated when a user watches a media file; and

a sending module 102, configured to send the reaction information to a media file server, so that after receiving the reaction information sent by at least one terminal device, the media file server generates marking information of the media file and sends the marking information of the media file to a terminal device that plays the media file.

The terminal device in this embodiment is configured to execute a technical solution of the method embodiment shown in FIG. 5, and implementation principles and technical effects of the terminal device are similar and are not described herein again.

Further, in the embodiment shown in FIG. 10, the marking information of the media file includes a category identifier of the media file; and the sending module 102 is specifically configured to send the reaction information to the media file server, so that after receiving the reaction information sent by the at least one terminal device, the media file server generates the category identifier of the media file and sends the category identifier of the media file to the terminal device that plays the media file.

Further, in the embodiment shown in FIG. 10, the marking information of the media file includes a reaction line graph of the media file; the collecting module 101 is specifically configured to collect the reaction information generated when the user watches the media file, and time information corresponding to the reaction information generated when the user watches the media file; and the sending module 102 is specifically configured to send, to the media file server, the reaction information and the time information that corresponds to the reaction information generated when the user watches the media file, so that after receiving the reaction information sent by the at least one terminal device, and the time information corresponding to the reaction information generated when the user watches the media file, the media file server generates the reaction line graph and sends the reaction line graph to the terminal device that plays the media file, where the reaction line graph includes a correspondence between reaction information of which a proportion is highest in one time unit when the media file is played, and the one time unit.

Further, in the embodiment shown in FIG. 10, the collecting module 101 is specifically configured to collect, by using a peripheral device, the reaction information generated when the user watches the media file, where the peripheral device includes at least one of the following: a voice collecting device, a video collecting device, and a physiology collecting device; and the reaction information includes at least one of the following: sound information, expression information, action information, and physiological information.

The terminal device provided in the embodiment shown in FIG. 10 may be the first terminal device in the foregoing embodiments.

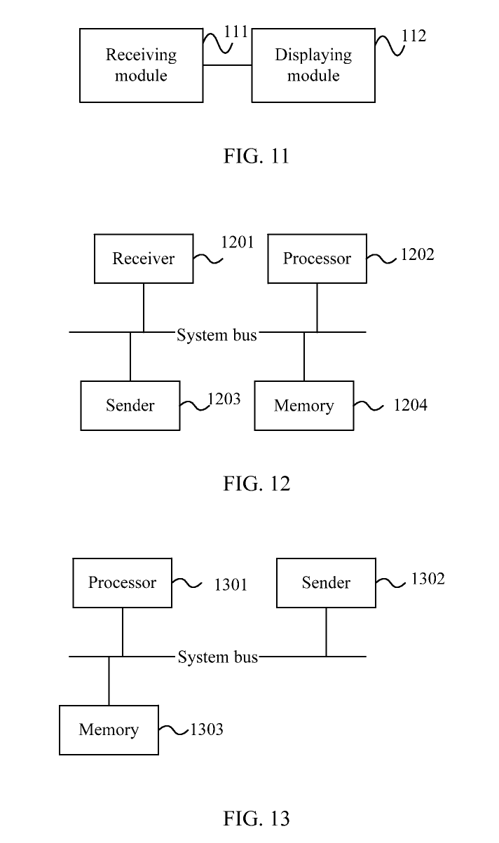

FIG. 11 is a schematic structural diagram of Embodiment 2 of a terminal device according to an embodiment of the present invention. As shown in FIG. 11, the terminal device in this embodiment includes:

a receiving module 111, configured to receive marking information, sent by a media file server, of a media file, where the marking information of the media file is generated after the media file server receives reaction information collected by at least one first terminal device when a user watches the media file; and

a displaying module 112, configured to display the marking information of the media file.

The terminal device in this embodiment is configured to execute a technical solution of the method embodiment shown in FIG. 7, and implementation principles and technical effects of the terminal device are similar and are not described herein again.

Further, in the embodiment shown in FIG. 11, the marking information of the media file includes a category identifier of the media file; the receiving module 111 is specifically configured to receive the category identifier, sent by the media file server, of the media file, where the category identifier of the media file is generated after the media file server receives the reaction information collected by the at least one first terminal device when the user watches the media file; and the displaying module 112 is specifically configured to display the category identifier of the media file on a display page or in the user interface of the media file.

Further, in the embodiment shown in FIG. 11, the marking information of the media file includes a reaction line graph of the media file; the receiving module 111 is specifically configured to receive the reaction line graph, sent by the media file server, of the media file, where the reaction line graph of the media file is generated after the media file server receives the reaction information collected by the at least one first terminal device when the user watches the media file, and time information corresponding to the reaction information generated when the user watches the media file, where the reaction line graph includes a correspondence between reaction information of which a proportion is highest in one time unit when the media file is played, and the one time unit; and the displaying module 112 is specifically configured to display the correspondence between reaction information of which a proportion is highest in one time unit of the media file and the one time unit on a playing page of the media file.

Further, in the embodiment shown in FIG. 11, the displaying module 112 is further configured to display the category identifier of the media file on the display page of the media file, where the category identifier of the media file is a category identifier corresponding to the reaction information of which the proportion is highest in the one time unit and the proportion is higher than a preset threshold.

Further, in the embodiment shown in FIG. 11, the reaction information includes at least one of the following: sound information, expression information, action information, and physiological information.

The terminal device provided in the embodiment shown in FIG. 11 may be the second terminal device in the foregoing embodiments.

FIG. 12 is a schematic structural diagram of Embodiment 2 of a media file server according to an embodiment of the present invention. As shown in FIG. 12, the media file server in this embodiment includes: a receiver 1201, a processor 1202, and a sender 1203. Optionally, the media file server may further include a memory 1204. The receiver 1201, the processor 1202, the sender 1203, and the memory 1204 may be connected by using a system bus or in another manner, and an example of being connected by using a system bus is used in FIG. 12. The system bus may be an Industrial Standard Architecture (Industrial Standard Architecture, ISA) bus, a Peripheral Component Interconnect (Peripheral Component Interconnect, PCI) bus, an Extended Industrial Standard Architecture (Extended Industrial Standard Architecture, EISA) bus, or the like. The system bus may be classified into an address bus, a data bus, a control bus, and the like. To facilitate illustration, only one line is used in FIG. 12 to represent the bus, but it does not indicate that there is only one bus or only one type of buses.

The receiver 1201 is configured to receive reaction information that is generated when a user watches a media file and is sent by at least one first terminal device, where the reaction information is collected by the first terminal device when the user watches the media file.

The processor 1202 is configured to generate marking information of the media file according to the reaction information sent by the at least one first terminal device.

The sender 1203 is configured to sends the marking information of the media file to a second terminal device that plays the media file, so that the second terminal device displays the marking information of the media file.

The memory 1204 is configured to store information received by the receiver 1201 and store data processed by the processor 1203, and send stored data by using the sender 1203.

The media file server in this embodiment is configured to execute a technical solution of the method embodiment shown in FIG. 2, and implementation principles and technical effects of the media file server are similar and are not described herein again.

Further, in the embodiment shown in FIG. 12, the marking information of the media file includes a category identifier of the media file; the processor 1202 is specifically configured to generate the category identifier of the media file according to the reaction information sent by the at least one first terminal device; and the sender 1203 is specifically configured to send the category identifier of the media file to the second terminal device that plays the media file, so that the second terminal device displays the category identifier of the media file on a display page or in the user interface of the media file.

Further, in the embodiment shown in FIG. 12, the marking information of the media file includes a reaction line graph of the media file; the receiver 1201 is further configured to receive time information corresponding to the reaction information sent by the at least one first terminal device; the processor 1202 is specifically configured to generate the reaction line graph according to the reaction information sent by the at least one first terminal device, and the time information corresponding to the reaction information, where the reaction line graph includes a correspondence between reaction information of which a proportion is highest in one time unit when the media file is played, and the one time unit; and the sender 1203 is specifically configured to send the reaction line graph of the media file to the second terminal device that plays the media file, so that the second terminal device displays the correspondence between reaction information of which a proportion is highest in one time unit of the media file and the one time unit on a playing page of the media file.

Further, in the embodiment shown in FIG. 12, the processor 1202 is further configured to use a category identifier corresponding to the reaction information of which the proportion is highest in the one time unit and the proportion is higher than a preset threshold as the category identifier of the media file; and the sender 1203 is specifically configured to send the category identifier of the media file to the second terminal device that plays the media file, so that the second terminal device displays the category identifier of the media file.

Further, in the embodiment shown in FIG. 12, the reaction information includes at least one of the following: sound information, expression information, action information, and physiological information.

FIG. 13 is a schematic structural diagram of Embodiment 3 of a terminal device according to an embodiment of the present invention. As shown in FIG. 13, the terminal device in this embodiment includes: a processor 1301, and a sender 1302. Optionally, the media file server may further include a memory 1303. The processor 1301, the sender 1302, and the memory 1303 may be connected by using a system bus or in another manner, and an example of being connected by using a system bus is used in FIG. 13. The system bus may be an ISA bus, a PCI bus, an EISA bus, or the like. The system bus may be classified into an address bus, a data bus, a control bus, and the like. To facilitate illustration, only one line is used in FIG. 13 to represent the bus, but it does not indicate that there is only one bus or only one type of buses.

The processor 1301 is configured to collect reaction information generated when a user watches a media file.

The sender 1302 is configured to send the reaction information to a media file server, so that after receiving the reaction information sent by at least one terminal device, the media file server generates marking information of the media file and sends the marking information of the media file to a terminal device that plays the media file.

The memory 1303 is configured to store data processed by the processor 1301, and send stored data by using the sender 1302.

The terminal device in this embodiment is configured to execute a technical solution of the method embodiment shown in FIG. 5, and implementation principles and technical effects of the terminal device are similar and are not described herein again.

Further, in the embodiment shown in FIG. 13, the marking information of the media file includes a category identifier of the media file; and the sender 1302 is specifically configured to send the reaction information to the media file server, so that after receiving the reaction information sent by the at least one terminal device, the media file server generates the category identifier of the media file and sends the category identifier of the media file to the terminal device that plays the media file.

Further, in the embodiment shown in FIG. 13, the marking information of the media file includes a reaction line graph of the media file; the processor 1301 is specifically configured to collect the reaction information generated when the user watches the media file, and time information corresponding to the reaction information generated when the user watches the media file; and the sender 1302 is specifically configured to send the reaction information and the time information that corresponds to the reaction information generated when the user watches the media file, so that after receiving the reaction information sent by the at least one terminal device, and the time information corresponding to the reaction information generated when the user watches the media file, the media file server generates the reaction line graph and sends the reaction line graph to the terminal device that plays the media file, where the reaction line graph includes a correspondence between reaction information of which a proportion is highest in one time unit when the media file is played, and the one time unit.

Further, in the embodiment shown in FIG. 13, the processor 1301 is specifically configured to collect, by using a peripheral device, the reaction information generated when the user watches the media file, where the peripheral device includes at least one of the following: a voice collecting device, a video collecting device, and a physiology collecting device; and

the reaction information includes at least one of the following: sound information, expression information, action information, and physiological information.

The terminal device provided in the embodiment shown in FIG. 13 may be the first terminal device in the foregoing embodiments.

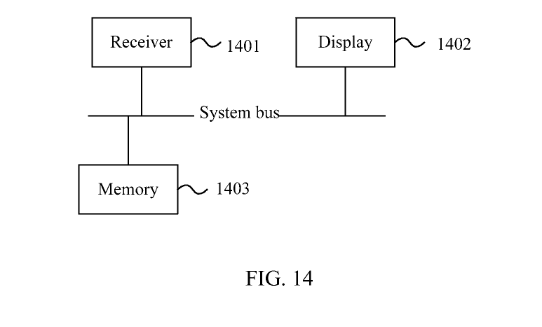

FIG. 14 is a schematic structural diagram of Embodiment 4 of a terminal device according to an embodiment of the present invention. As shown in FIG. 14, the terminal device in this embodiment includes: a receiver 1401, and a display 1402. Optionally, the terminal device may further include a memory 1403. The receiver 1401, the display 1402, and the memory 1403 may be connected by using a system bus or in another manner, and an example of being connected by using a system bus is used in FIG. 14. The system bus may be an ISA bus, a PCI bus, an EISA bus, or the like. The system bus may be classified into an address bus, a data bus, a control bus, and the like. To facilitate illustration, only one line is used in FIG. 14 to represent the bus, but it does not indicate that there is only one bus or only one type of buses. The display 1402 may be any display device that can implement a display function.

The receiver 1401 is configured to receive marking information, sent by a media file server, of a media file, where the marking information of the media file is generated after the media file server receives reaction information collected by at least one first terminal device when a user watches the media file.

The display 1402 is configured to display the marking information of the media file.

The terminal device in this embodiment is configured to execute a technical solution of the method embodiment shown in FIG. 7, and implementation principles and technical effects of the terminal device are similar and are not described herein again.

Further, in the embodiment shown in FIG. 14, the marking information of the media file includes a category identifier of the media file; the receiver 1401 is specifically configured to receive the category identifier, sent by the media file server, of the media file, where the category identifier of the media file is generated after the media file server receives the reaction information collected by the at least one first terminal device when the user watches the media file; and the display 1402 is specifically configured to display the category identifier of the media file on a display page or in the user interface of the media file.

Further, in the embodiment shown in FIG. 14, the marking information of the media file includes a reaction line graph of the media file; the receiver 1401 is specifically configured to receive the reaction line graph, sent by the media file server, of the media file, where the reaction line graph of the media file is generated after the media file server receives the reaction information collected by the at least one first terminal device when the user watches the media file, and time information corresponding to the reaction information generated when the user watches the media file, where the reaction line graph includes a correspondence between reaction information of which a proportion is highest in one time unit when the media file is played, and the one time unit; and the display 1402 is specifically configured to display the correspondence between reaction information of which a proportion is highest in one time unit of the media file and the one time unit on a playing page of the media file.

Further, in the embodiment shown in FIG. 14, the display 1402 is further configured to display a category identifier of the media file on a display page or in the user interface of the media file, where the category identifier of the media file is a category identifier corresponding to the reaction information of which the proportion is highest in the one time unit and the proportion is higher than a preset threshold.

Further, in the embodiment shown in FIG. 14, the reaction information includes at least one of the following: sound information, expression information, action information, and physiological information.

The terminal device provided in the embodiment shown in FIG. 14 may be the second terminal device in the foregoing embodiments.

Persons of ordinary skill in the art may understand that all or some of the steps of the method embodiments may be implemented by a program instructing relevant hardware. The program may be stored in a computer-readable storage medium. When the program runs, the steps of the method embodiments are performed. The foregoing storage medium includes: any medium that can store program code, such as a ROM, a RAM, a magnetic disc, or an optical disc.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

1. A media file server, comprising:
a receiving module, configured to receive reaction information that is generated when a user watches a media file and is sent by at least one first terminal device, wherein the reaction information is collected by the at least one first terminal device when the user watches the media file;
a processing module, configured to generate marking information of the media file according to the reaction information sent by the at least one first terminal device; and
a sending module, configured to send the marking information of the media file to a second terminal device that plays the media file, to enable the second terminal device to display the marking information of the media file.

2. The media file server according to claim 1, wherein the marking information of the media file comprises a category identifier of the media file;
the processing module is configured to generate the category identifier of the media file according to the reaction information sent by the at least one first terminal device; and
the sending module is configured to send the category identifier of the media file to the second terminal device that plays the media file, to enable the second terminal device to display the category identifier of the media file on a display page or in a user interface of the media file.

3. The media file server according to claim 1, wherein the marking information of the media file comprises a reaction line graph of the media file;
the receiving module is further configured to receive time information corresponding to the reaction information sent by the at least one first terminal device;
the processing module is configured to generate a reaction line graph according to the reaction information sent by the at least one first terminal device, and generate the time information corresponding to the reaction information, wherein the reaction line graph comprises a correspondence between reaction information of which a proportion is highest in one time unit when the media file is played, and the one time unit; and
the sending module is configured to send the reaction line graph of the media file to the second terminal device that plays the media file, to enable the second terminal device to display the correspondence between reaction information of which a proportion is highest in one time unit of the media file and the one time unit on a playing page of the media file.

4. The media file server according to claim 3, wherein the processing module is further configured to use a category identifier corresponding to the reaction information of which the proportion is highest in the one time unit and the proportion is higher than a preset threshold as a category identifier of the media file; and
the sending module is configured to send the category identifier of the media file to the second terminal device that plays the media file, to enable the second terminal device to display the category identifier of the media file.

5. The media file server according to claim 1, wherein the reaction information comprises at least one of the following: sound information, expression information, action information, and physiological information.

6. A terminal device, comprising:
a collecting module, configured to collect reaction information generated when a user watches a media file; and
a sending module, configured to send the reaction information to a media file server, to enable the media file server to generate marking information of the media file and send the marking information of the media file to another terminal device that plays the media file, after receiving the reaction information sent by at least one terminal device.

7. The terminal device according to claim 6, wherein the marking information of the media file comprises a category identifier of the media file; and
the sending module is configured to send the reaction information to the media file server, to enable the media file server to generate the category identifier of the media file and send the category identifier of the media file to the terminal device that plays the media file, after receiving the reaction information sent by the at least one terminal device.

8. The terminal device according to claim 6, wherein the marking information of the media file comprises a reaction line graph of the media file;
the collecting module is configured to collect the reaction information generated when the user watches the media file, and time information corresponding to the reaction information generated when the user watches the media file; and
the sending module is configured to send, to the media file server, the reaction information and the time information that corresponds to the reaction information generated when the user watches the media file, to enable the media file server to generate the reaction line graph and send the reaction line graph to the another terminal device that plays the media file, after receiving the reaction information sent by the at least one terminal device, and the time information corresponding to the reaction information generated when the user watches the media file;
wherein the reaction line graph comprises a correspondence between reaction information of which a proportion is highest in one time unit when the media file is played, and the one time unit.

9. The terminal device according to claim 6, wherein the collecting module is configured to collect, by using a peripheral device, the reaction information generated when the user watches the media file, wherein the peripheral device comprises at least one of the following: a voice collecting device, a video collecting device, and a physiology collecting device; and
the reaction information comprises at least one of the following: sound information, expression information, action information, and physiological information.

10. A terminal device, comprising:
a receiving module, configured to receive marking information of a media file, sent by a media file server, wherein the marking information of the media file is generated after the media file server receives reaction information collected by at least one first terminal device when a user watches the media file; and
a displaying module, configured to display the marking information of the media file.

11. The terminal device according to claim 10, wherein the marking information of the media file comprises a category identifier of the media file;
the receiving module is configured to receive the category identifier of the media file, sent by the media file server, wherein the category identifier of the media file is generated after the media file server receives the reaction information collected by the at least one first terminal device when the user watches the media file; and
the displaying module is configured to display the category identifier of the media file on a display page or in a user interface of the media file.

12. The terminal device according to claim 10, wherein the marking information of the media file comprises a reaction line graph of the media file;
the receiving module is configured to receive the reaction line graph of the media file, sent by the media file server, wherein the reaction line graph of the media file is generated after the media file server receives the reaction information collected by the at least one first terminal device when the user watches the media file, and time information corresponding to the reaction information generated when the user watches the media file, wherein the reaction line graph comprises a correspondence between reaction information of which a proportion is highest in one time unit when the media file is played, and the one time unit; and
the displaying module is configured to display the correspondence between reaction information of which a proportion is highest in one time unit of the media file and the one time unit on a playing page of the media file.

13. The terminal device according to claim 12 wherein the displaying module is further configured to display a category identifier of the media file on a display page or in a user interface of the media file, wherein the category identifier of the media file corresponds to the reaction information of which the proportion is highest in the one time unit and the proportion is higher than a preset threshold.

14. The terminal device according to claim 10, wherein the reaction information comprises at least one of the following: sound information, expression information, action information, and physiological information.
